(19) United States
(12) Patent Application Publication
(10) Pub. No.: US 2024/0429764 A1
(43) Pub. Date: Dec. 26, 2024

(54) METHODS AND SYSTEMS FOR AN ELECTRIC MACHINE

(71) Applicant: Ford Global Technologies, LLC, Dearborn, MI (US)

(72) Inventors: Raphael Koch, Odenthal (DE); Viktor Haeuser, Burscheid (DE)

(21) Appl. No.: 18/740,150

(22) Filed: Jun. 11, 2024

(30) Foreign Application Priority Data
Jun. 22, 2023 (DE) 102023116442.2

(51) Int. Cl. H02K 1/32; H02K 1/276; H02K 9/19

(52) U.S. Cl. CPC H02K 1/32; H02K 1/276; H02K 9/19

(57) ABSTRACT

Methods and systems are provided for an electrical machine including a shaft configured to rotate about an axis of rotation, a rotor coupled to the shaft and a stator, wherein the rotor includes a first axial end face, a second axial end face, a lateral surface, and at least two cooling channels, wherein the cooling channels each extend into the rotor from an injection opening in the first axial end face, and at least one injection nozzle configured to spray a fluid into the injection opening of the cooling channels when the rotor is rotating.

### CROSS REFERENCE TO RELATED APPLICATION

The present application claims priority to German Patent Application No. 102023116442.2 filed on Jun. 22, 2023. The entire contents of the above-listed application is hereby incorporated by reference for all purposes.

### FIELD

The present description relates generally to an electrical machine and a method for operating such an electrical machine. Further disclosed is an electrically powered vehicle.

### BACKGROUND/SUMMARY

An increasing number of vehicles are being electrified such that an electric machine is arranged to supply power to wheels. Operating parameters of vehicles may be adjusted to enhance operation of the electric machine. Particularly with high loads or power, the resulting thermal power loss causes considerable heat development in electrical machines. This may reduce the efficiency of the electrical machine even further, as ohmic losses in the motor usually increase with increasing temperature. Alternatively, modern electrical machines include a large number of materials, some of which are heat-sensitive. Permanent magnets in synchronous machines in particular may lose their magnetization at higher temperatures from approximately 150° C.

There is therefore a need to eliminate or at least reduce the disadvantages of known systems without having to compromise on the extent of known solutions. In particular, there is a need to optimize electrical machines in terms of performance/power density and efficiency and to provide an appropriate cooling concept for electrical machines.

The issues described above may be at least partially solved by an electrical machine including a shaft configured to rotate about an axis of rotation, a rotor coupled to the shaft and a stator, wherein the rotor includes a first axial end face, a second axial end face, a lateral surface, and at least two cooling channels, wherein the cooling channels each extend into the rotor from an injection opening in the first axial end face, and at least one injection nozzle configured to spray a fluid into the injection opening of the cooling channels when the rotor is rotating.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 illustrates a perspective view of a rotor with an injection nozzle;

FIG. 2 illustrates a perspective view of a rotor with four injection nozzles;

FIG. 3 illustrates a rear view of a rotor;

FIG. 4 illustrates a first sectional view of an electric machine;

FIG. 5 illustrates a second sectional view of the electric machine;

FIG. 6 illustrates a third sectional view of the electric machine;

FIG. 7 illustrates a side view of the third sectional view;

FIG. 8 illustrates a fourth sectional view of the electric machine;

FIG. 9 illustrates a fifth sectional view of the electric machine;

FIG. 10 illustrates a sectional view of the rear view of the rotor;

FIG. 11 illustrates a schematic view of a vehicle; and

FIG. 12 illustrates a method for operating a cooling system of the electric machine.

### DETAILED DESCRIPTION

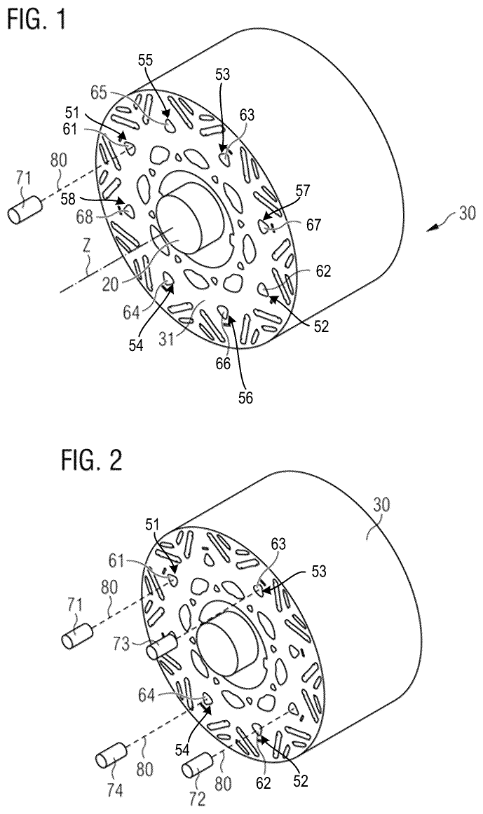

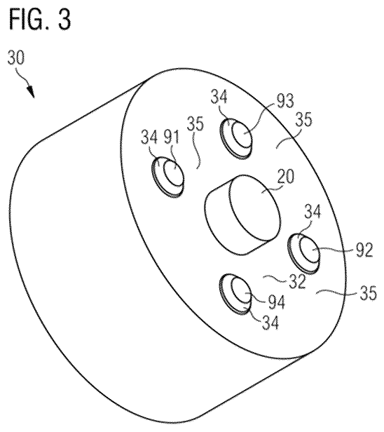

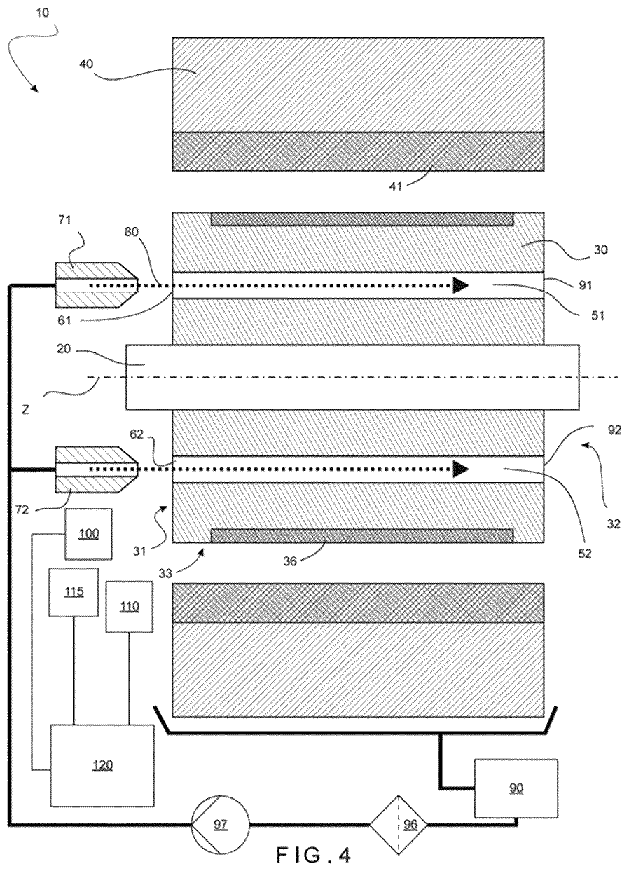

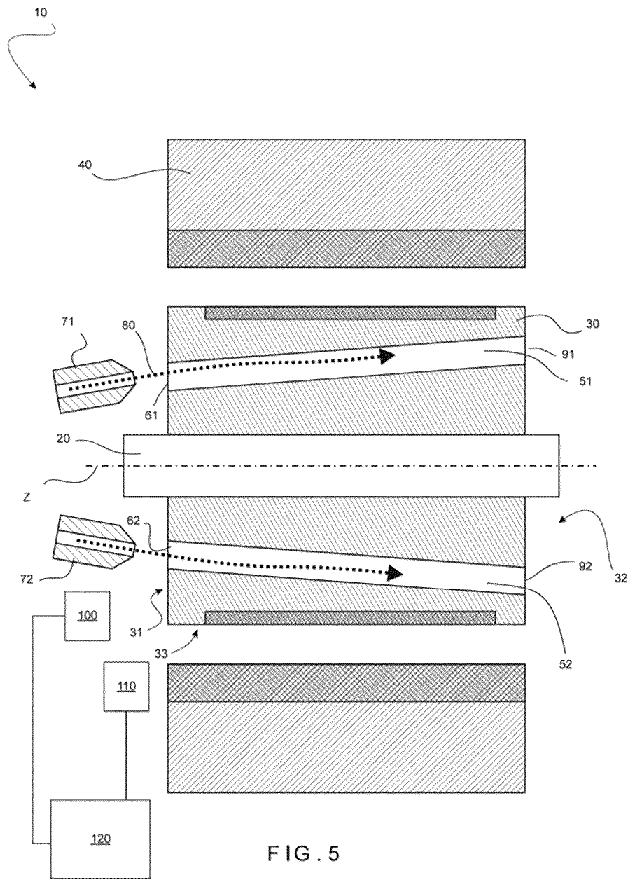

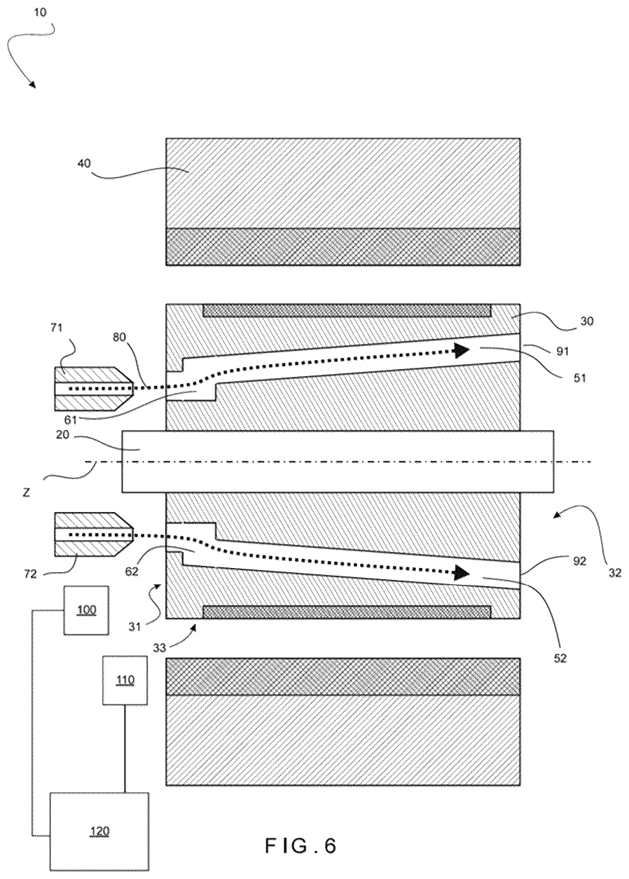

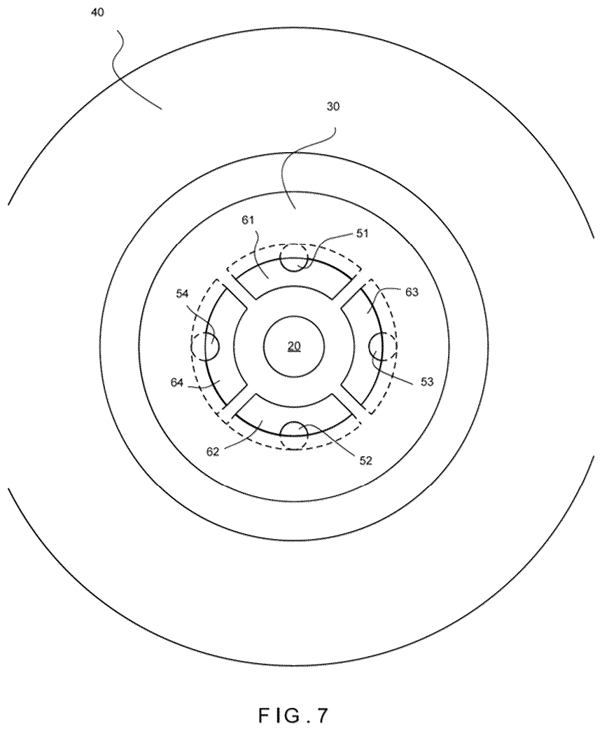

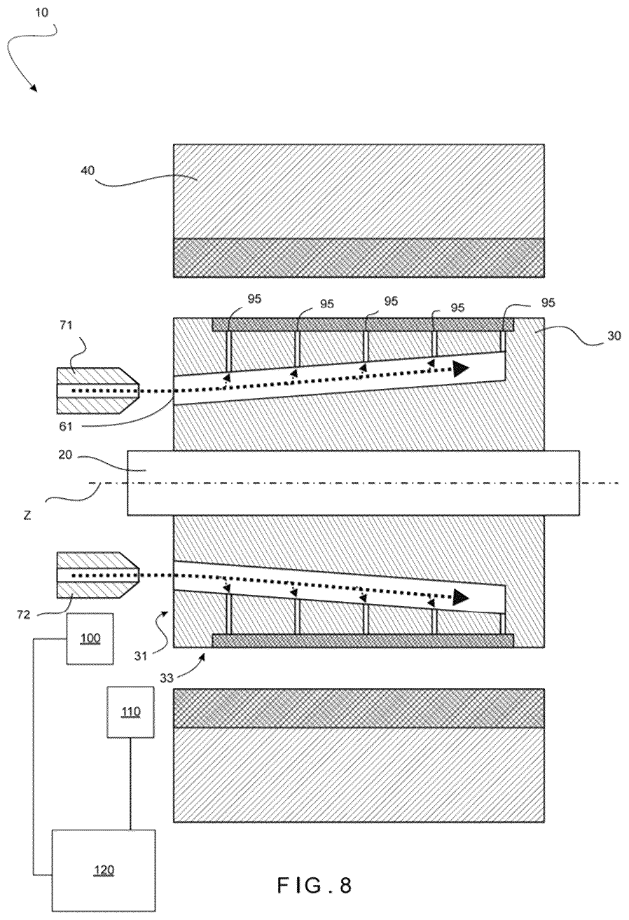

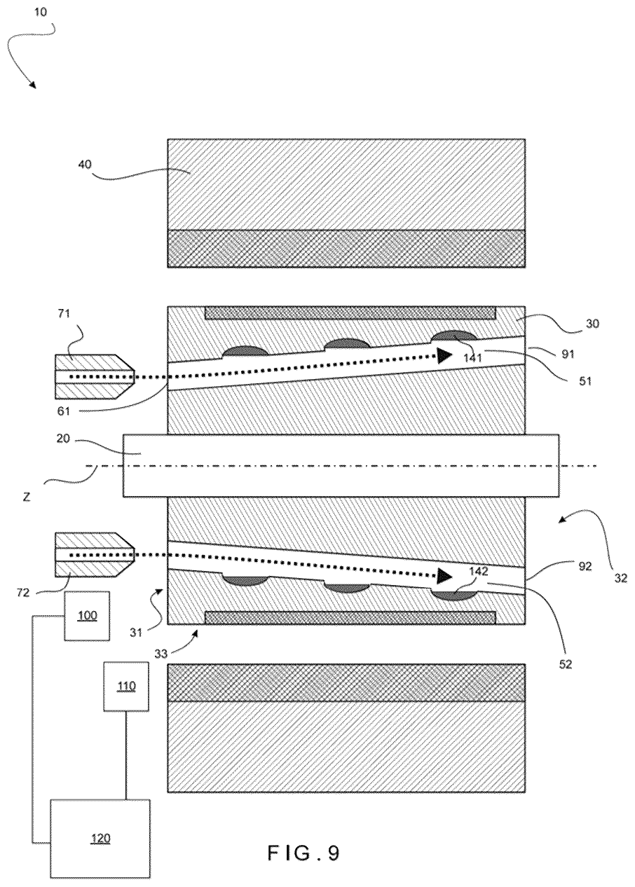

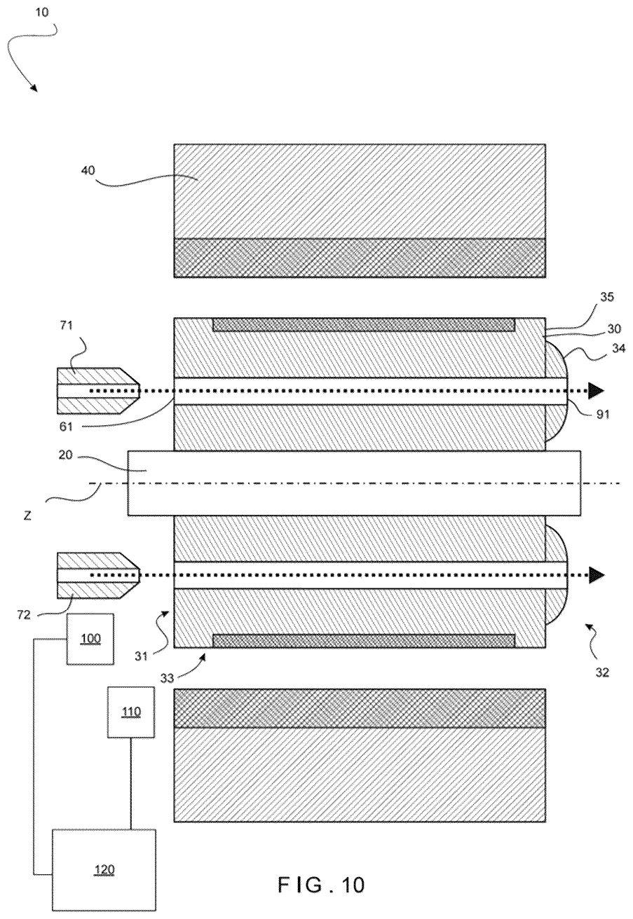

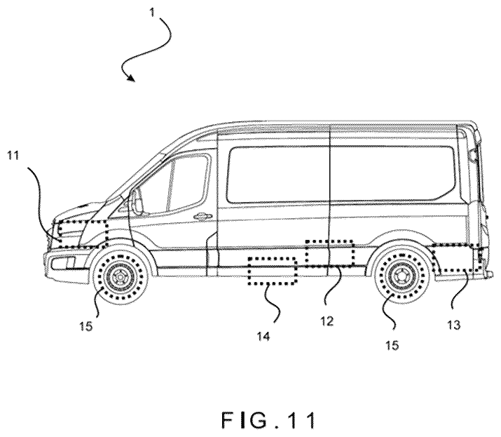

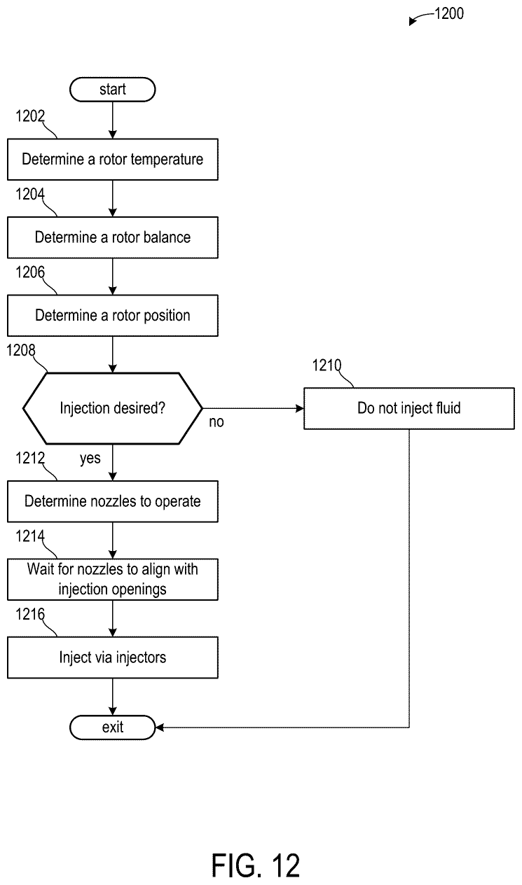

The following description relates to systems and methods for an electric machine. FIG. 1 illustrates a perspective view of a rotor with an injection nozzle. FIG. 2 illustrates a perspective view of a rotor with four injection nozzles. FIG. 3 illustrates a rear view of a rotor. FIG. 4 illustrates a first sectional view of an electric machine. FIG. 5 illustrates a second sectional view of the electric machine. FIG. 6 illustrates a third sectional view of the electric machine. FIG. 7 illustrates a side view of the third sectional view. FIG. 8 illustrates a fourth sectional view of the electric machine. FIG. 9 illustrates a fifth sectional view of the electric machine. FIG. 10 illustrates a sectional view of the rear view of the rotor. FIG. 11 illustrates a schematic view of a vehicle. FIG. 12 illustrates a method for operating a cooling system of the electric machine.

In one example, the electric machine includes a plurality of cooling channels, the cooling channels each extend from an injection opening in the first axial end face into the rotor.

The electrical machine also has at least one associated injection nozzle, which is designed and arranged in the electrical machine in such a way that a cooling fluid may be injected through the at least one injection nozzle into the injection openings of the cooling channels when the rotor is rotating.

Due to the specific configuration of the electrical machine described above, the rotor may be cooled fluidly without the need for a co-rotating clutch.

Losses are also reduced that may occur due to turbulent flows if the rotor were fully or partially immersed in the cooling fluid and rotating in the cooling fluid.

The cooling fluid may be sprayed continuously from the injection nozzle. However, only the portion of the volume flow that is injected into the injection opening of the cooling channels is used to cool the entire rotor. Cooling fluid that does not reach the injection openings is driven outwards along the rotor surface at the end face by centrifugal force and drips off the rotor.

It is therefore advantageous if the cooling fluid is only sprayed by the injection nozzle when the injection opening of a cooling channel is located directly in front of the injection nozzle. To achieve this, the rotor position may be monitored using a suitable sensor. A suitable control device then synchronizes the activation of the associated injection pump with the rotor position.

In some embodiments, the cooling ducts are shaped in such a way that the injected cooling fluid flows through the cooling ducts in a predetermined direction, in particular away from the injection opening, at least from a minimum rotor speed.

For example, the cooling channels may be shaped in such a way that no portion of the cooling channels has a smaller radial distance from the axis of rotation than the injection openings. In other words, the cooling channels are configured in such a way that they move further away from the axis of rotation as the distance from the injection opening increases. This results in the cooling fluid flowing away from the injection opening due to the centrifugal force when the rotor is rotating.

Alternatively or additionally, the cooling channels may extend through the rotor and have one or more outlet openings in the second axial end face or in the lateral surface. The cooling fluid may exit through the outlet opening. In one embodiment, the outlet opening is at a greater radial distance from the axis of rotation than the injection opening.

Embodiments may include where the at least one injection nozzle is arranged in the electrical machine in such a way that the injection nozzle has an injection direction aligned parallel to the rotatable shaft. Alternatively, the injection direction may include a radial, outwardly directed directional component. With suitably shaped cooling channels, the amount of recirculated cooling fluid may be minimized. This optimizes the efficiency of the cooling system.

In a further embodiment, a rotor surface area around the outlet opening of the cooling channels may be raised in the radial or axial direction relative to a rotor surface surrounding said rotor surface area in such a way that a local negative pressure caused by the Bernoulli effect in the area of the outlet opening supports the flow of cooling fluid through the cooling channels. In other words, the geometry of the rotor is such that the relative air velocity caused by the rotation of the rotor is higher at the outlet opening of a cooling channel than at its injection opening, or higher than in the area surrounding the outlet opening. The resulting pressure difference leads to a local vacuum, which forces the cooling fluid out of the cooling channel.

In one example, the electrical machine comprises one or more temperature sensors for detecting the temperature of the rotor.

For example, sensors for direct and contact measurement with thermocouples or resistance thermometers may be used for this purpose. The disadvantage here is the fact that the sensor signal must reach the control device from the rotating rotor. However, contacting electrical solutions, such as slip rings, are quite prone to errors. An alternative solution with non-contact transmission of the measurement signal is again expensive.

In some embodiments, the temperature may be measured indirectly and without contact, for example using a radiation pyrometer. This measurement method is also referred to as IR temperature measurement.

Furthermore, the electrical machine may comprise one or more sensors for detecting an imbalance of the rotor. An imbalance may, for example, be detected directly via suitable load cells at the bearing points or indirectly by measuring the wobbling motion of the rotor caused by the imbalance. A suitable control device may then counteract the imbalance by injecting additional cooling fluid into selected cooling channels in such a quantity that the center of gravity of the rotor shifts back to the axis of rotation.

The control device may adjust the time sequence of the injection of the cooling fluid into the injection opening and/or the volume of the cooling fluid injected into certain cooling channels as a function of the sensor data recorded.

In one example, a fluid reservoir and a pump arranged in fluidic terms between the reservoir and the at least one injection nozzle are associated with the electrical machine. The pump and the reservoir may be integrated into the electrical machine or provided separately.

The injectors may include an integrated injection pump. Piezo injectors may be suitable. They are fast-switching and enable short injection distances. In addition, the injected fluid volume may be set precisely. Piezo injectors are capable of injecting approximately 1000 ml/minute into the cooling channels.

A proposed method of operating the electrical machine described above may comprise the following method steps of detecting a rotor position of the rotor recurrently or continuously with a corresponding sensor for detecting the rotor position. Optionally, a rotor temperature of the rotor may be monitored with one or more temperature sensors to record the rotor temperature. An imbalance of the rotor is also detected with one or more sensors for detecting an imbalance of the rotor. A cooling fluid is repeatedly injected by the injection nozzles into the corresponding injection openings of the cooling ducts.

The quantity of fluid injected and/or an injection sequence or the resulting injected volume flow is set by a control device assigned to the electrical machine as a function of the sensor data recorded.

The injected cooling fluid is then forced through the cooling channels.

This may be done by continuously injecting cooling fluid, displacing cooling fluid already present in the cooling channels.

Alternatively, the centrifugal force resulting from the rotation of the rotor may be used to drive the cooling fluid through the correspondingly shaped cooling channels.

Additionally or alternatively, a pressure difference between the inlet and outlet of the cooling channel caused by the Bernoulli effect may also be used to suck the coolant out of the cooling channel at the cooling channel outlet.

The cooling concept described may ensure reliable cooling of the electrical machine. It is efficient and has a simple mechanical design.

According to a further aspect, a vehicle with an electrical machine as described above is also provided.

In this context, a vehicle is understood to be a device that is configured for the transportation of objects, freight or people between different destinations. Examples of vehicles include land-based vehicles such as motor vehicles, electric vehicles, hybrid vehicles or the like, rail vehicles, aircraft or watercraft. In one example, vehicles in the present context may be considered road-based vehicles, such as cars, trucks, buses or the like.

In advantageous embodiments, the electrical machine described above may be arranged in the vehicle as a front motor, mid-mounted motor, underfloor motor or wheel hub motor, for example.

All of the features described with regard to the various aspects may be combined individually or in (sub) combinations with other aspects.

The following detailed description in conjunction with the accompanying drawings, in which like numerals refer to like elements, is intended as a description of various embodiments of the disclosed subject matter and is not intended to represent the only embodiments. Any embodiment described in this disclosure is by way of example or illustration only and should not be construed as preferential or advantageous over other embodiments. The illustrative examples contained herein are not intended to be exhaustive and do not limit the claimed subject matter to the precise forms disclosed. Various variations of the described embodiments will be readily apparent to those skilled in the art, and the general principles defined herein may be applied to other embodiments and applications without departing from the spirit and scope of the described embodiments. Therefore, the described embodiments are not limited to the embodiments shown, but have the widest possible scope of application consistent with the principles and features disclosed herein.

All features disclosed below with respect to the embodiments and/or accompanying figures may be combined alone or in any sub-combination with features of aspects of the present disclosure, including features of preferred embodiments, provided that the resulting combination of features is useful to a person skilled in the art.

For the purposes of the present disclosure, the phrase “at least one of A, B and C” means, for example, (A), (B), (C), (A and B), (A and C), (B and C) or (A, B and C), including all other possible combinations when more than three elements are listed. In other words, the term “at least one of A and B” generally means “A and/or B”, namely “A” alone, “B” alone or “A and B”.

FIG. 1 shows a simplified, perspective view of a rotor 30 with an associated injection nozzle 71. The rotor 30 is fixed to a rotatable shaft 20. An associated stator of the electrical machine, as well as a housing, is not shown in this figure. The rotor 30 has a first and a second axial end face (e.g., axial surface) 31, a lateral surface and at least two cooling channels 51-58 or, in the exemplary embodiment shown, eight cooling channels 51, 52, 53, 54, 55, 56, 57, and 58. The cooling channels 51-58 are evenly spaced and arranged rotationally symmetrically around the axis of rotation Z. As such, several cooling ducts 51-58 have the same distance from the axis of rotation in each case, so that they are located successively at the same position in front of the injection nozzle during the rotation of the rotor 30. The cooling channels 51-58 each extend from an injection opening 61-68 in the first axial end face 31 into the rotor 30. In one example, the cooling channel 51 is associated with the injection opening 61. The cooling channel 52 is associated with the injection opening 62. The cooling channel 53 is associated with the injection opening 63. The cooling channel 54 is associated with the injection opening 64. The cooling channel 55 is associated with the injection opening 65. The cooling channel 56 is associated with the injection opening 66. The cooling channel 57 is associated with the injection opening 67. The cooling channel 58 is associated with the injection opening 68.

The injection nozzle 71 is configured and arranged in the electrical machine in such a way that, when the rotor 30 is rotating, the cooling fluid 80 may be injected through the at least one injection nozzle 71 into the injection openings 61-68 of the cooling channels 51-58.

The injection nozzle 71 may include an injection direction aligned parallel to the rotatable shaft 20.

Turning now to FIG. 2, it shows an embodiment of an electrical machine, but with four injection nozzles 71-74 arranged on a circular path around the axis of rotation Z. As such, components previously introduced are similarly numbered in this and subsequent figures.

The more injection nozzles are used, the more cooling channels 51-58 may be loaded with cooling fluid 80 at the same time. In this way, imbalances may be compensated for more quickly and the quantity of cooling fluid 80 injected at the same time may be increased.

As an alternative to the embodiments shown, the injection nozzles 71-74 may also be arranged at different distances from the axis of rotation Z. Each of the injection nozzles would then only supply a part of the cooling channels 51-58 with cooling liquid 80, namely the part that lies on a common circular path around the axis of rotation Z.

The rotors 30 shown in all embodiments may be rotors of both permanently excited synchronous machines (PSM) and asynchronous machines (ASM). The cooling concept presented is suited for both types of electrical machines.

Turning now to FIG. 3, it shows the rotor 30 from the rear in a simplified perspective view. The cooling channels extend through the rotor 30 and emerge in the second axial end face 32 on the rear side, each with an outlet opening 91-94. The cooling fluid emerges from the outlet openings 91-94, is then thrown outwards by the centrifugal force and drips off the stator. In this way, the stator is also cooled secondarily. In one example, the cooling channel 51 corresponds to the outlet opening 91. The cooling channel 52 corresponds to the outlet opening 92. The cooling channel 53 corresponds to the outlet opening 93. The cooling channel 54 corresponds to the outlet opening 94.

A bead is formed around the outlet opening 91-94, which tapers with increasing distance from the second end face 32.

In other words, a rotor surface region 34 around the outlet openings 91-94 is raised in the radial or axial direction relative to a rotor surface 35 surrounding the rotor surface region 34 in such a way that a local negative pressure in the region of the outlet opening 91-94 caused by the Bernoulli effect supports the flow of the cooling fluid 80 through the cooling channels 51-58.

Turning now to FIG. 4, it shows a simplified schematic sectional view of an electrical machine 10 with a rotor 30 as already described with reference to FIGS. 1 to 3. A stator 40 is also shown. Furthermore, it is not relevant whether the electrical machine shown is an asynchronous machine, a permanently excited synchronous machine or another type of motor. Therefore, stator windings 41 and rotor bars 36 of an asynchronous motor are only shown schematically by way of example.

The cooling fluid 80 is injected through two injection nozzles 71, 72 into cooling channels 51, 52 parallel to the rotor shaft 20. Cooling fluid 80 injected later will push cooling fluid 80 already in the cooling ducts 51, 52 ahead of it until it emerges again at the outlet openings 91, 92 of the cooling ducts 51, 52.

The electrical machine 10 comprises one or more temperature sensors 100 for detecting the rotor temperature. The control device 120 may adjust the quantity of coolant 80 injected into the rotor 30 as a function of the rotor temperature. In particular, the control device 120 may increase the quantity injected if the rotor temperature rises and/or exceeds predefined threshold values.

The electrical machine 10 further comprises a sensor 115 for detecting the rotor position so that the injection nozzles 71, 72 are only activated and spray cooling liquid 80 when the injection openings 61, 62 of the cooling channels 51, 52 are directly in front of the respective injection nozzles 71, 72.

In addition, the electrical machine 10 comprises one or more sensors 110 for detecting an imbalance of the rotor. If an imbalance is detected by the control device 120, it may counteract the imbalance by injecting more cooling liquid 80 on the opposite side of the rotor 30 in order to shift the center of gravity of the rotor 30 loaded with cooling liquid 80 back to the axis of rotation Z.

For this purpose, the control device 120 changes the time sequence of the injection of the cooling fluid 80 into the injection openings 61-62 and or a volume flow of the injected cooling fluid 80 depending on the recorded sensor data.

After the cooling fluid 80 seeps through between the vanes of the rotor pack or exits at the outlet openings 91, 92 of the cooling channels 51, 52, it is propelled outwards at the rotor 30 and against the stator 40. The stator 40 is thus advantageously cooled secondarily. The cooling fluid 80 may be projected both onto the coil sides within the slots and against the winding heads. The winding heads are thus actively cooled.

Over time, the cooling fluid 80 collects on the underside of the stator 40, drips off there and is collected in a reservoir 90. The coolant 80 may be filtered in a filter 96, it is pumped by a pump 97 to the injection nozzles 71, 72, where it is available again.

The coolant circuit described and shown here has been omitted from the other figures solely for reasons of simplification. However, it is clear to the skilled person that the technical teaching may be readily transferred to the other embodiments.

Turning now to FIG. 5, it shows another variant of an electrical machine 10. It differs from the previous exemplary embodiment in that the injection direction of the injection nozzles 71, 72 has a radial, outwardly directed directional component. Said another way, the injection nozzles 71, 72 inject in a direction angled to an axis of rotation Z.

In addition, the cooling ducts 51-52 are shaped in such a way that the injected cooling fluid 80 flows through the cooling ducts 51-52 at least from a minimum speed of the rotor 30.

This is achieved by shaping the cooling channels 51-52 in such a way that the distance of the free cross-section of the cooling channel 51-52 from the axis of rotation Z increases, at least in portions, with increasing distance from the injection openings 61, 62.

In particular, the outlet openings 91-92 have a greater radial distance from the axis of rotation Z than the injection openings 61-62.

No portion of the cooling channels 51-52 is located closer to the axis of rotation Z than the injection openings 61-62. This prevents coolant 80 from being conveyed out on the wrong side of the rotor 30, namely at the injection openings 61, 62, by the centrifugal force.

In all embodiments shown above and below, the cooling channels 51-58 extend along the axis of rotation Z. Whenever the electrical machine 10 has a dominant direction of rotation, for example when it is used as a traction motor in a vehicle 1, the cooling ducts 51-58 may also spiral around the axis of rotation Z like a double or multiple helix.

FIG. 6 and FIG. 7 show a further alternative variant of the electrical machine 10, in which the inlet openings 61-64 of the cooling channels 51-54 are pocket-shaped, with an edge extending radially from the outside to the inside preventing the injected cooling liquid 80 from flowing out. Said another way, the cooling channels 51-54 may include a bend or other feature that deviates from linear. In this way, fluid in the cooling channels 51-54 may be forced to turn or curve.

In this way, injection times may be greatly extended. In addition, the requirements for precise timing are reduced.

Through the cooling channels 51-54 arranged radially on the outside of the inlet openings 61-64, the injected cooling fluid 80 is pressed completely into the rotor 30 by the resulting centrifugal forces.

Due to the narrow webs between the pockets, it is possible for the injection nozzles 71-74 to be operated continuously without large quantities of coolant 80 flowing past the rotor 30 unused.

Turning now to FIG. 8 it shows an embodiment that differs from the previous embodiments in that the cooling channels extend into the rotor 30, but do not exit again on the second end face. As such, the embodiment of FIG. 8 may not include the outlets 91-94 described above.

The cooling fluid 80 exits through a large number of thin, outwardly directed channels 95 directly at the lateral surface 33 of the rotor 30. In this way, for example, rotor windings may be cooled. The stator 40 is also evenly wetted over its entire inner surface by centrifuged cooling fluid 80.

Turning now to FIG. 9, it shows a further embodiment including additional cavities 141, 142, i.e. extensions, in some portions, of the cooling channels 51-52 radially outwards, are provided. Cooling fluid 80 collects in the cavities 141, 142 until the respective cavity 141, 142 is filled. Only then does the excess cooling fluid continue to flow in the direction of the second end face 32. In one example, the cavities are recesses arranged on a radially outward surface of the rotor. In this way, additionally cooling may be provided to an outer circumference of the rotor 30.

Turning now to FIG. 10, it shows a simplified sectional view of the rotor 30 of FIG. 3 in the electrical machine 10.

Turning now to FIG. 11, it shows a simplified, schematic representation of a vehicle 1 in a side view. The vehicle 1 has at least one electrical machine 10, as described above. The electrical machine 10 may, for example, be arranged in the vehicle 1 as a front motor 11, mid-mounted motor 12, rear motor 13, underfloor motor 14 or wheel hub motor 15.

Reference may be made to quantities and numbers in the present application. Unless expressly stated, such quantities and numbers are not to be regarded as limiting, but as examples of the possible quantities or numbers in the context of the present application. In this context, the term “plural” may also be used in the present application to refer to a quantity or number. In this context, the term “plural” means any number greater than one, e.g., two, three, four, five, etc. The terms “about”, “approximately”, “near”, etc. mean plus or minus 5% of the stated value.

Although the disclosure has been illustrated and described with reference to one or more embodiments, the skilled person will be able to make equivalent changes and modifications after reading and understanding this description and the accompanying drawings.

Turning now to FIG. 12, it shows a method 1200 for operating the cooling system of the rotor. Instructions for carrying out method 1200 may be executed by a controller (e.g., control device 120 of FIG. 4) based on instructions stored on a memory of the controller and in conjunction with signals received from sensors of the system, such as the sensors described above with reference to FIG. 4. The controller may employ actuators of the system to adjust operation, according to the method described below.

The method 1200 begins at 1202, which includes determining a rotor temperature. The rotor temperature. The rotor temperature may be measured directly or indirectly as described above.

At 1204, the method 1200 may include determining an imbalance of the rotor. The imbalance may be detected via monitoring an eccentricity of the rotor. Additionally or alternatively, a rotational speed of the rotor may be uneven through a single rotation of the rotor if the rotor is imbalanced.

At 1206, the method 1200 may include determining a position of the rotor. In one example, the position may be determined based on a relationship between the nozzle and the injection opening.

At 1208, the method 1200 may include determining if an injection is desired. Injection may be desired if the rotor temperature is greater than a threshold temperature and/or if a rotor imbalance is detected. In one example, the injection operation may be adjusted if only the rotor temperature is greater than the threshold temperature, if only the rotor imbalance is detected, or if both the rotor temperature is greater than the threshold temperature and the imbalance is detected.

If the injection is not desired then at 1210, the method 1200 may include not injecting fluid into the cooling channels of the rotor.

If the injection is desired, then at 1212, the method 1200 may include determining which injection nozzles to operate and an amount of fluid to inject through each. For example, if only the rotor temperature is greater than the threshold temperature, then each of the injection nozzles may be operated to inject an equal amount of fluid. As another example, if only the imbalance is detected, then injection nozzles corresponding to injection openings designated to relieve the imbalance may be operated. As a further example, if the rotor temperature is greater than the threshold temperature and the imbalance is detected, then each of the injection nozzles may be operated. However, some of the injection nozzles may inject different amounts of fluid to relieve the imbalance while also providing cooling. In one example, the injectors spraying toward an area of the rotor with less mass may inject more fluid to relieve the imbalance.

At 1214, the method 1200 may include waiting until the injection nozzles are aligned with the injection openings of the cooling channels.

At 1216, the method 1200 may include injecting via the injectors. As such, the selected injectors may be operated to inject fluid toward the cooling channels.

In one example, a method for operating an electrical machine may include optionally detecting a rotor position of the rotor via a sensor for detecting the rotor position. The method may further include optionally detecting a rotor temperature of the rotor via one or more temperature sensors for detecting the rotor temperature. The method may additionally include detecting an imbalance of the rotor in an electrical machine via one or more sensors for detecting an unbalance of the rotor. The method may include injecting a cooling fluid into the injection openings of the cooling channels via the at least one injection nozzle, in particular wherein a quantity of the injected fluid and/or a time sequence of the injection is set by a control device assigned to the electrical machine as a function of detected sensor data. The method may further include conveying the injected cooling fluid in the cooling channels, in particular via centrifugal forces resulting from the rotation of the rotor and acting on the cooling fluid and/or a local negative pressure caused by the Bernoulli effect in the region of the outlet openings.

The disclosure also provides support for an electric machine, comprising: a shaft configured to rotate about an axis of rotation, a rotor coupled to the shaft and a stator, wherein the rotor comprises a first axial end face, a second axial end face, a lateral surface, and at least two cooling channels, wherein the cooling channels each extend into the rotor from an injection opening in the first axial end face, and at least one injection nozzle configured to spray a fluid into the injection opening of the cooling channels when the rotor is rotating. In a first example of the system, the cooling channels are linear. In a second example of the system, optionally including the first example, a radial distance between the cooling channels and the axis of rotation is greater than or equal to a radial distance between the injection opening and the axis of rotation. In a third example of the system, optionally including one or both of the first and second examples, the at least one injection nozzle comprises an injection direction parallel to the axis of rotation. In a fourth example of the system, optionally including one or more or each of the first through third examples, the at least one injection nozzle comprises an injection direction angled to the axis of rotation. In a fifth example of the system, optionally including one or more or each of the first through fourth examples, the cooling channels comprise an outlet arranged in the second axial end face or in the lateral surface. In a sixth example of the system, optionally including one or more or each of the first through fifth examples, a rotor surface region adjacent to the outlet is raised.

The disclosure also provides support for a system, comprising: an electric machine comprising a rotor configured to rotate about an axis of rotation, a plurality of cooling channels extending through at least a portion of the rotor, a plurality of injection nozzles that are stationary and configured to inject fluid, and a controller with computer-readable instructions stored on memory thereof that when executed cause the controller to: determine a temperature of the rotor, determine an imbalance of the rotor, and inject fluid via one or more of the plurality of injection nozzles based on the temperature and the imbalance. In a first example of the system, an injection opening of a cooling channel of the plurality of cooling channels is radially closer to the axis of rotation than an outlet of the cooling channel. In a second example of the system, optionally including the first example, the plurality of cooling channels comprises a bend. In a third example of the system, optionally including one or both of the first and second examples, the plurality of cooling channels expel fluid radially outward toward a stator. In a fourth example of the system, optionally including one or more or each of the first through third examples, the instructions further cause the controller to inject an equal amount of fluid via each of the plurality of injection nozzles when only the temperature of the rotor is greater than a threshold temperature. In a fifth example of the system, optionally including one or more or each of the first through fourth examples, the instructions further cause the controller to inject different amounts of fluid via two or more of the plurality of injection nozzles when only the imbalance of the rotor is determined. In a sixth example of the system, optionally including one or more or each of the first through fifth examples, the instructions further cause the controller to inject different amount of fluid via the plurality of injection nozzles when each of the temperature of the rotor is greater than a threshold temperature and the imbalance of the rotor is determined. In a seventh example of the system, optionally including one or more or each of the first through sixth examples, the plurality of injection nozzles is arranged at an angle.

The disclosure also provides support for a system, comprising: an electric machine comprising a rotor configured to rotate about an axis of rotation, a plurality of cooling channels extending through a portion of the rotor, wherein each of the plurality of cooling channels comprises an inlet arranged in an axial surface of the rotor, a plurality of injection nozzles configured to inject fluid toward the inlet, and a controller with computer-readable instructions stored on memory thereof that when executed cause the controller to: operate the plurality of injection nozzles to correct an imbalance of the rotor. In a first example of the system, the instructions further cause the controller to operate the plurality of injection nozzles to decrease a temperature of the rotor. In a second example of the system, optionally including the first example, the plurality of cooling channels is non-parallel to the axis of rotation. In a third example of the system, optionally including one or both of the first and second examples, each of the plurality of cooling channels comprises an outlet arranged in a second axial surface opposite the axial surface of the rotor. In a fourth example of the system, optionally including one or more or each of the first through third examples, each of the plurality of cooling channels comprises an outlet arranged in a radial surface normal to the axial surface.

FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Note that the example control and estimation routines included herein may be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology may be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric machine, comprising:
a shaft configured to rotate about an axis of rotation;
a rotor coupled to the shaft and a stator, wherein the rotor comprises a first axial end face, a second axial end face, a lateral surface, and at least two cooling channels, wherein the at least two cooling channels each extend into the rotor from an injection opening in the first axial end face; and
at least one injection nozzle configured to spray a fluid into the injection opening of the at least two cooling channels when the rotor is rotating.

2. The electric machine of claim 1, wherein the at least two cooling channels are linear.

3. The electric machine of claim 1, wherein a radial distance between the at least two cooling channels and the axis of rotation is greater than or equal to a radial distance between the injection opening and the axis of rotation.

4. The electric machine of claim 1, wherein the at least one injection nozzle comprises an injection direction parallel to the axis of rotation.

5. The electric machine of claim 1, wherein the at least one injection nozzle comprises an injection direction angled to the axis of rotation.

6. The electric machine of claim 1, wherein the at least two cooling channels comprise an outlet arranged in the second axial end face or in the lateral surface.

7. The electric machine of claim 6, wherein a rotor surface region adjacent to the outlet is raised.

8. A system, comprising:
an electric machine comprising a rotor configured to rotate about an axis of rotation;
a plurality of cooling channels extending through at least a portion of the rotor;
a plurality of injection nozzles that are stationary and configured to inject fluid; and
a controller with computer-readable instructions stored on memory thereof that when executed cause the controller to:
determine a temperature of the rotor;
determine an imbalance of the rotor; and
inject fluid via one or more of the plurality of injection nozzles based on the temperature and the imbalance.

9. The system of claim 8, wherein an injection opening of a cooling channel of the plurality of cooling channels is radially closer to the axis of rotation than an outlet of the cooling channel.

10. The system of claim 8, wherein the plurality of cooling channels comprises a bend.

11. The system of claim 8, wherein the plurality of cooling channels expel fluid radially outward toward a stator.

12. The system of claim 8, wherein the instructions further cause the controller to inject an equal amount of fluid via each of the plurality of injection nozzles when only the temperature of the rotor is greater than a threshold temperature.

13. The system of claim 8, wherein the instructions further cause the controller to inject different amounts of fluid via two or more of the plurality of injection nozzles when only the imbalance of the rotor is determined.

14. The system of claim 8, wherein the instructions further cause the controller to inject different amounts of fluid via the plurality of injection nozzles when each of the temperature of the rotor is greater than a threshold temperature and the imbalance of the rotor is determined.

15. The system of claim 8, wherein the plurality of injection nozzles is arranged at an angle.

16. A system, comprising:
an electric machine comprising a rotor configured to rotate about an axis of rotation;
a plurality of cooling channels extending through a portion of the rotor, wherein each of the plurality of cooling channels comprises an inlet arranged in an axial surface of the rotor;
a plurality of injection nozzles configured to inject fluid toward the inlet; and
a controller with computer-readable instructions stored on memory thereof that when executed cause the controller to:
operate the plurality of injection nozzles to correct an imbalance of the rotor.

17. The system of claim 16, wherein the instructions further cause the controller to operate the plurality of injection nozzles to decrease a temperature of the rotor.

18. The system of claim 16, wherein the plurality of cooling channels is non-parallel to the axis of rotation.

19. The system of claim 16, wherein each of the plurality of cooling channels comprises an outlet arranged in a second axial surface opposite the axial surface of the rotor.

20. The system of claim 16, wherein each of the plurality of cooling channels comprises an outlet arranged in a radial surface normal to the axial surface.
